(19) United States
(12) Patent Application Publication
(10) Pub. No.: US 2024/0155321 A1
(43) Pub. Date: May 9, 2024

(54) Location-Based Services and Wireless Emergency Alert for Neutral Host with System Information Block Broadcasts Based on Private Network Tracking Area Code ID ad Cell ID

(71) Applicant: Celona, Inc., Campbell, CA (US)

(72) Inventor: Srinivasan Balasubramanian, San Diego, CA (US)

(21) Appl. No.: 18/506,609

(22) Filed: Nov. 10, 2023

Related U.S. Application Data
(63) Continuation-in-part of application No. 17/822,098, filed on Aug. 24, 2022.
(60) Provisional application No. 63/424,257, filed on Nov. 10, 2022.
(60) Provisional application No. 63/426,315, filed on Nov. 17, 2022.
(60) Provisional application No. 63/238,001, filed on Aug. 27, 2021.
(60) Provisional application No. 63/241,164, filed on Sep. 7, 2021.

(51) Int. Cl. H04W 4/90; H04W 4/029; H04W 4/12

(52) U.S. Cl. CPC H04W 4/90; H04W 4/029; H04W 4/12

(57) ABSTRACT

A system and method are provided for sending alert messages to end users. Based on a location component, one or more particular UEs (User Equipment) that communicate via a private network are determined. Directing an emergency message to a subset of Access Points (APs) within a private network based on the one or more particular UEs determined. In some embodiments, an Identifier Mapping Database (IMD) maps the Mobile Network Operator (MNO) identifiers to Private CBRS/Non-Public Network (PCNN) identifiers. In some embodiments, a roaming connection is established between the private network and the MNO network. In some embodiments, a UE cell ID is mapped to an AP based on a notification area.

### CROSS-REFERENCE TO RELATED APPLICATIONS—CLAIM OF PRIORITY

The present application claims priority to U.S. Provisional Application No. 63/424,257, filed Nov. 10, 2022, entitled “Location Based Services and Wireless Emergency Alert for Neutral Host with System Information Block Broadcasts Based on Private Network Tracking Area Code ID and Cell ID”, and to U.S. Provisional Application No. 63/426,315, filed Nov. 17, 2022, entitled “CBRS RAN Sharing for Neutral Hosting”, which are both herein incorporated by reference in their entirety. This application is also a continuation-in-part, and claims priority to, U.S. Non-Provisional application Ser. No. 17/822,098, filed Aug. 24, 2022, entitled “Location Based Services and Wireless Emergency Alert for Neutral Host”, which application claims priority to U.S. Provisional Application No. 63/238,001, filed Aug. 27, 2021, entitled “Location Based Services and Wireless Emergency Alert for Neutral Host”, and to U.S. Provisional Application No. 63/241,164, filed Sep. 7, 2021, entitled “Location Based Services and Wireless Emergency Alert for Neutral Host”, which are all herein incorporated by reference in their entirety.

### BACKGROUND

### (1) Technical Field

The disclosed method and apparatus relate generally to systems for managing and directing a transmission of public warning system (PWS) message. In particular, the disclosed method and apparatus relate to directing one and only one PWS message to components of a neutral host.

### (2) Background

The current 3rd Generation Partnership Project (3GPP) and Global System for Mobile Communications Association (GSMA) standards forums are typically directed to writing specifications for subscription management for large Mobile Network Operators (MNOs) that typically have nationwide coverage hosting a large number of users. Two particular technical specifications written by 3GPP are (1) 3GPP TS 22.168 Earthquake and Tsunami Warning System (ETWS) requirements; Stage 1 and (2) 3GPP TS 22.268 Public Warning System (PWS) requirements. These specifications provide technical information regarding how PWS messages and other warnings are transmitted to users of the communications systems relevant to 3GPP. However, since these specifications are directed primarily to the MNOs, issues arise that are not addressed in the 3GPP technical specification when it is desirable to direct warnings to UEs (User Equipment) connected through a private/non-public communications network. For example, issues arise when a private campus in which a CBRS (Citizens Broadband Radio System) defined by CBRS Alliance Network Services Technical Specification_CBRSA-TR-1001 is deployed and through which the UEs receive communications. In some cases, a MOCN (Multi-Operator Core Network) gateway serves as a single point through which communications from a UE are directed to one of several different network cores.

One architecture includes a CBRS MOCN in accordance with the 3GPP EPS system architecture as specified in 3GPP TS23.401, as published by 3GPP, and other associated specifications. In such cases, a RAN (Radio Access Network) entity may be shared between multiple EPCs as specified in 3GPP TS 23.251. Each EPC (Evolved Packet Core) is associated with a PLMN-ID (Public Land Mobile Network Identifier). UEs use the Shared CBRS RAN for connecting to their selected PLMN. Interaction between the Shared CBRS RAN and a SAS (Spectrum Access System) is assumed for CBRS spectrum management. A high level view of the baseline architecture is illustrated in FIG. 7. FIG. 8 illustrates a Functional breakdown with MOCN GW (gateway).

FIG. 9 illustrates public network to neutral host transitions with MOCN GW.
The MOCN GW (GateWay) acts similar to the functional implementation for LTE (Long Term Evolution) based NH (Neutral Host) operation.
The LTE S1-C/S1-U is replaced with N2/N3 interfaces for NR (new radio).
The RAN network deployed in the enterprise is shared across enterprise operation and across one or more MNO PLMNs.
The RAN functions of CU (Central Unit)/DU (Distributed Unit)/RU (Remote Unit) will be deployed in the enterprise network.
The user authentication, IP (Internet Protocol) allocation, and QoS (Quality of Service) operations are managed from the MNO (Mobile Network Operator) core.
MOCN GW support will keep it uniform across LTE and NR networks.
   3GPP Rel-15 (Release 15) based NR SA (Stand Alone) NH operation
The enterprise network includes the MNO-PLMN along with the other PLMNs in its broadcasts.
UE is provisioned with the MNO-PLMN; Procedures used to find the LTE enterprise network for camping is used for 3GPP Rel-15 based NR SA enterprise network camping.
   Transitioning from LTE macro to enterprise NR.
      Macro network populates the SIB24 (System Information Block 24) listing the enterprise NR cells as neighbors;
   Transitioning from NR macro to enterprise NR.
      Macro network populates the SIB3 listing the enterprise NR cells as neighbors.

### SUMMARY

In at least some embodiments, a system is provided that includes an Identifier Mapping Database (IMD), which is located within a Private CBRS/Non-Public Network (PCNN). The IMD enables the mapping of Mobile Network Operator (MNO) identifiers to PCNN identifiers. An MNO IMD is located within an MNO network, and the MNO IMD maps PCNN identifiers to MNO identifiers. As a result, the MNO stores information via which a UE in a target notification region can be identified, and an alert message can be sent to the UE in a target notification area.

In at least some embodiments, the MNO network determines identification information of an endpoint (e.g., an end user or a user of a mobile phone or another network device) within a network, based on identifiers of the MNO (by accessing the IMD). The MNO sends the identification information to a private network. An alert message is routed, by the private network, to the endpoint based on the identification information. Based on information in the alert message, information associated with a target notification area is provided to a private network gateway by a Multi-Operator Core Network Non-Public (MOCN). In at least some embodiments, the network includes multiple MNOs. A single MNO is chosen for performing the determination of the identification information. The choice of which MNO is used is based on the target notification area and a Neutral Host (NH) within the target notification area. The private network is configured to route the message provided from only one of the MNOs. A private network device retrieves a message, including emergency alerts. The private network device determines the destination information of nodes where the broadcasts are intended to be sent based on a target notification area indicated in the message.

In some embodiments, a message is sent from a notification provider to an MNO and then forwarded by the MNO to a network device. The message is received at a network device, and the notification includes information about a target notification area. A private Access Point (AP) is determined by a message received at a network device. The AP can be used to broadcast an alert message to the UEs at the endpoints. A network device matches the endpoint sites to the target notification area, allowing the alert message to be sent to the endpoint sites.

In some embodiments, APs for a target notification region are identified. Target endpoints are determined for sending the alert message by a network device of a private network, and the network device matches the endpoint sites to the target notification area. In some embodiments, the contents of messages from different MNOs are combined, and duplicate alert messages are removed. In some embodiments, target notification areas are combined based on notifications received from the different MNO cores.

### BRIEF DESCRIPTION OF THE DRAWINGS

The disclosed method and apparatus, in accordance with one or more various embodiments, are described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration, these drawings are not necessarily made to scale.

FIG. 1 is a simplified illustration of the architecture of a communication system in which a UE (User Equipment) can receive emergency alerts from one or more Mobile Network Operator (MNO) networks

FIG. 2 is a block diagram of the architecture of a system for translating private network identifiers to MNO identifiers for receiving emergency alerts.

FIG. 3 is a block diagram of the architecture of NIMS SBA Architecture for receiving emergency alerts.

FIG. 4 is a block diagram of an S6a/S8-based neutral host architecture for receiving emergency alerts.

FIG. 5 is a block diagram of a neutral host roaming architecture for receiving emergency alerts.

FIG. 6 illustrates an S6a/S8-based neutral host Architecture.

FIG. 7 is an assumed baseline architecture for CBRS (Citizens Broadband Radio System) MOCN (Multi-Operator Core Network).

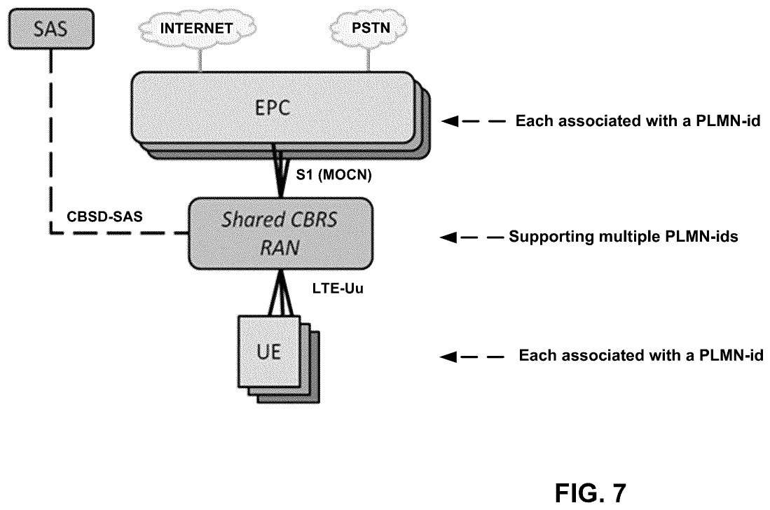

FIG. 8 illustrates a Functional breakdown with MOCN GW (gateway).

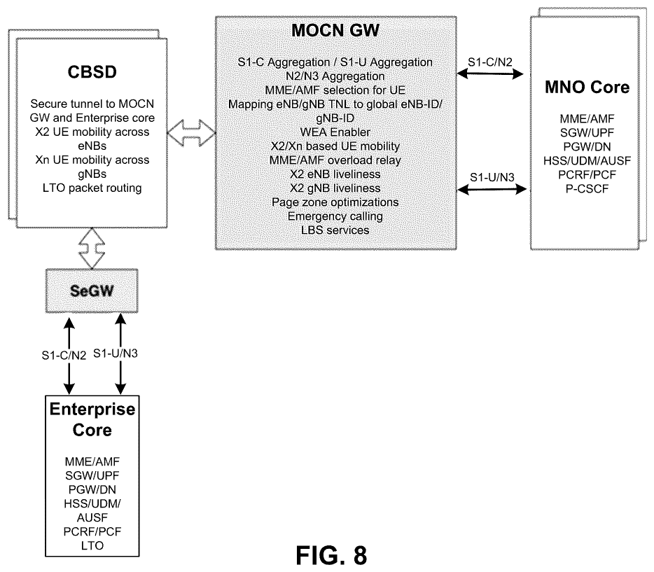

FIG. 9 illustrates public network to neutral host transitions with MOCN GW.

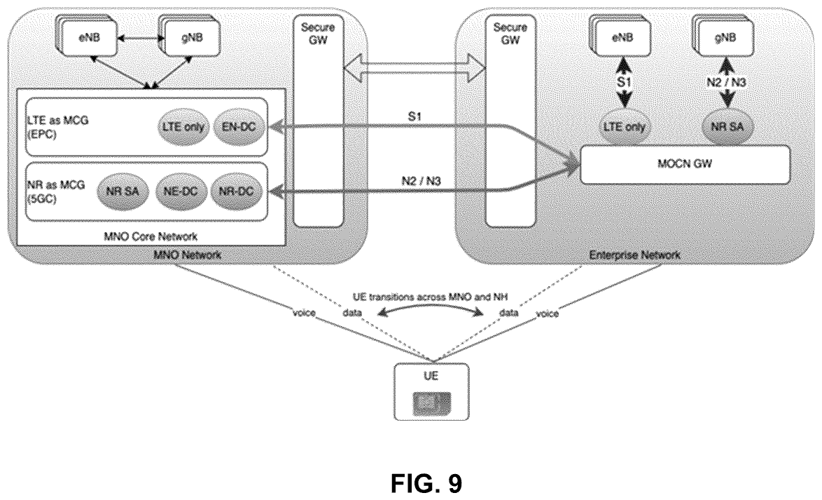

FIG. 10 is a map of FCC Economic Areas.

FIG. 11 is an illustration of the TAC-ID and CELL-ID are modified in connected mode.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

The disclosed method and apparatus provide a method and apparatus by which Public Warning System (PWS) messages or other emergency messages can be directed to a subset of APs within a private network. In some embodiments, the APs are eNBs (eNodeBs of a 4G network) or gNBs (gNodeBs of a 5G network). In some embodiments of the disclosed method and apparatus, the private network operates using a CBRS (Citizens Broadband Radio System) network architecture. In addition, in some embodiments, location components can request a particular UE (User Equipment) to provide location information in response to requests. Such requests may be made in accordance with LPP (Location Positioning Protocol) messaging between the location component and the UE. In some embodiments, the location component is an E-SMLC (Evolved Serving Mobile Location Center) of an MNO (Mobile Network Operator) network. The UE may be communicating through the private network. The LPP messaging may be communicated on a secure tunnel, such as an SLs (Security Labeling service) interface that allows the contents of such communications to be accessible only to the UE and the network location component (e.g., the E-SMLC). In some such embodiments, the response to the request includes information related to APs (access points) associated with local AP identifiers. In some such embodiments, a location component within the MNO network provides a mapping between the AP in the private network and an MNO AP that is unique within the MNO network. The local AP identifiers may not be unique for all PLMNs (Public Land Mobile Networks). Such local AP identifiers may be eNB/gNB IDs and TAIs.

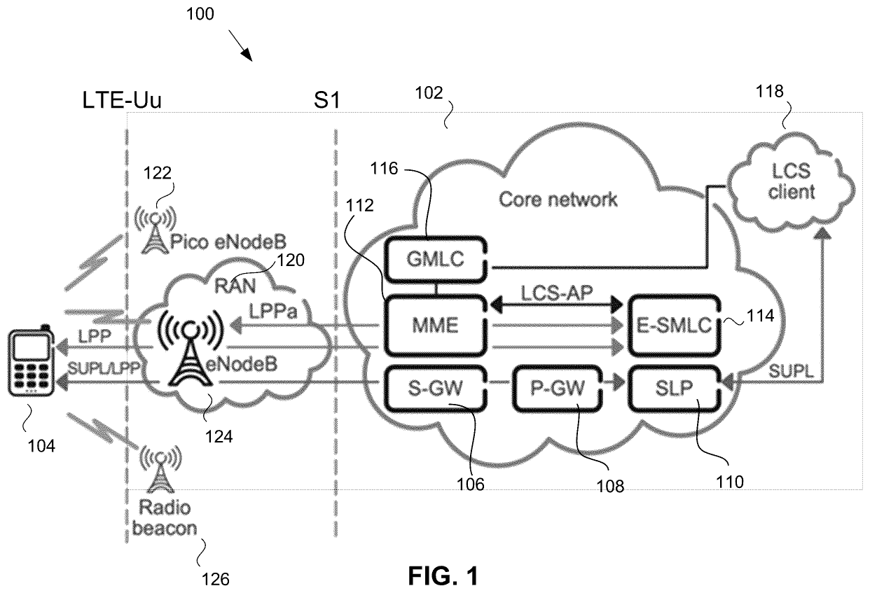

FIG. 1 is a simplified illustration of the architecture of a communication system 100. The communication system 100 includes a UE 104, and an MNO network 102. The MNO network 102 includes: an SGW 106, a PGW 108, an SUPL Location Platform (SLP) 110, Mobility Management Entity (MME) 112, an E-SMLC 114, a Gateway Mobile Location Centre (GMLC) 116, a Secure User Plane Location (SUPL) 114, an LCS client 118, a RAN 120, a pico gNodeB 122, eNodeB 124 and a radio beacon 126.

In the communication system 100, a UE 104 receives emergency alerts from one or more MNO networks 102. In addition, the UE 104 can answer requests for position location information sent to the UE 104 by the E-SMLC 114 within the MNO network 102 in response to the UE 104 placing an E-911 emergency call. The SGW 106 is part of the UP (User Plane). The SGW 106 forwards and routes packets to and from the RAN 120 and the PGW 108. The SGW 106 is a local mobility anchor for an inter-AP handover and mobility between networks. The PGW 108 acts as an interface between an LTE network and other packet data networks. The PGW 108 is the anchor point for network mobility and may act as the Policy and PCEF (Charging Enforcement Function), manage the QoS (Quality of Service), and provide packet inspection. SUPL (Secure User Plane Location) messaging is communicated between PGW 108 and LCS client 118.

### E-911 Calls in LTE

Generally, when a UE 104 places an E-911 emergency call, the call is routed to an LCS client 118. For an E-911 call, the particular LCS client 118 is a Public Safety Answering Point (PSAP). The PSAP, in coordination with an E-SMLC 114 within the MNO network 102, sends a request for the UE 104 to provide information regarding the location of the UE 104. The response provided by the UE 104 to the request for position location information may take many forms. In many cases, the response includes information that includes the identity of one or more components of the MNO network 102. For example, in some embodiments, the identity of the components of the MNO network 102 may include a Cell-ID of the pico eNB 122/gNB 124, the Cell-ID of the pico eNB 122/gNB 124, or an identifier associated with a radio beacon 116. Components within the MNO network 102, such as the E-SMLC 114, have a database of locations for each of the MNO components that might be identified in the response from the UE 104. Using one or more techniques for locating the UE 104, the location of the UE 104 can be determined from the information provided by the UE 104 in its response.

### Request for Commercial Location Based Services in LTE

Similar to the case in which an E-911 call is placed, when the UE 104 requests access to services that require the Location Service (LCS) client 114 to determine the location of the UE 104, the associated LCS client 118 attains the location of the UE 104, based on information provided by the UE 104. In some cases, the UE 104 provides the information in response to a request from the MNO network 102. Alternatively, the UE 104 provides the information in anticipation of the LCS client 118 needing to locate the UE 104. In either case, the E-SMLC 114 within the MNO network 102 provides the location of the UE 104 by calculating the location of the UE 104 with the assistance of the database of locations for each of the components of the MNO network 102 at issue, similar to the process that takes place in the case of an E-911 call, as noted above.

### Emergency Messages Sent Through the Public Warning System (PWS) in LTE

In cases in which an emergency message is sent from an LCS client 118, such as a source for Wireless Emergency Alerts (WEAs) from the Earthquake and Tsunami Warning System (ETWS), a group of eNBs/gNBs 114 (and possibly pico eNBs/gNBs 118 and radio beacons 116) within a particular geographic area are identified to receive the warning based on their location. The MNO has a complete list of all the pico eNB 122/gNB 124 and other such transmitters through which such alerts can be sent, and the messages can be directed to each using the Cell-ID of each such transmitter and also using a Tracking Area Identifier (TAI). The TAI identifies groups of transmitters (in the example of FIG. 1, one such group includes pico eNB 122/gNB 124), and the groups of transmitters are located within a particular geographic area. Thus, by sending a message with a TAI, the UEs within the geographic area of the group of transmitters using the TAI receive the emergency message.

### Private Networks

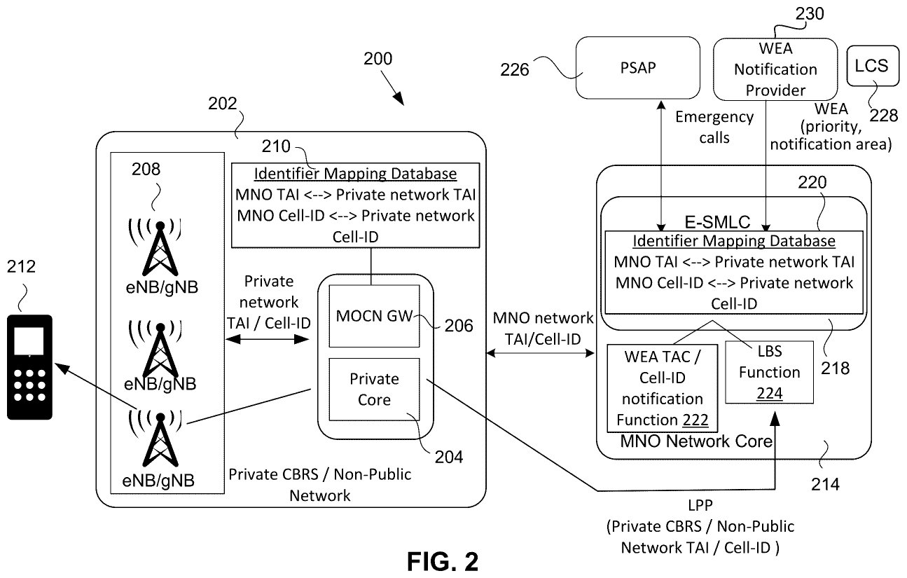

FIG. 2 is a simplified illustration of the architecture of a communication system 200 comprising components that operate in accordance with some embodiments of the disclosed method and apparatus. A Private CBRS/Non-Public Network (PCNN) 202 comprises a private network core 204, a Multi-Operator Core Network (MOCN) gateway 206, a plurality of eNBs/gNBs 208, an Identifier Mapping Database (IMD) 210, a UE 212, an E-SMLC 218, an MNO network core 214, an IMD 222, a PSAP 226, an LCS 228 and a WEA notification provider 230.

When a UE 212, such as a cellular telephone, communicates through an eNB 208, the communication between the UE and the core 204 carries a TAI and a Cell-ID (hereafter referred to collectively as “identifiers”). The Cell-ID serves as an eNB identifier. The identifiers are local to the PCNN 202. That is, the identifiers are unique within the PCNN 202. However, the identifiers may not be unique when other PLMNs are taken into account, such as the MNOs to which the PCNN 202 may be in communication through the MOCN gateway 206. Therefore, the PCNN identifiers are not useful for an MNO attempting to identify the transmitter associated with the Cell-ID or TAI.

Upon receiving the communication, in some embodiments, the MOCN gateway 206 accesses information stored within the IMD 210 to map the local PCNN identifiers to MNO identifiers for a particular MNO network. The particular MNO is determined based on information received in the communication from the UE 212. That is, the UE 212 provides information indicating to which MNO the UE 212 subscribes. The local PCNN identifiers are then mapped to the MNO identifiers associated with the MNO to which the UE 212 subscribes. In some embodiments, there is only one local Cell-ID for each MNO Cell-ID in the IMD 210. However, in other embodiments, an MNO Cell-ID may be mapped to more than one local Cell-ID. Similarly, in some embodiments, only one local TAI exists for a particular MNO TAI within the IMD 210. However, in other embodiments, an MNO TAI may be mapped in the IMD 210 to more than one local TAI.

### Use of the Same TAC-ID and Cell-ID for Neutral Host Deployments

In some embodiments, MNOs all align to use the same TAC-ID and Cell-ID for each neutral host deployment.

### TAC-ID

In some embodiments, the TAC can be to specify the “high byte” to use a specific value with the freedom for the individual neutral host deployments to use any of the 256 “low byte”.

For LTE and the currently available devices in the market for 5G NR do not support independent TACs per PLMN in the SIB (System Information Block) broadcasts and a single value needs to be used for all devices camping on the neutral host cell.

The support for per-PLMN TAC support feature can be introduced in the 5G NR neutral host networks but will require backward compatibility until the legacy devices are sunset. Once per-PLMN TAC-ID can be supported, this aspect becomes a non-issue.

### Cell-ID

In some embodiments, the Cell-IDs are uniquely assigned and when interpretable in the individual MNO cores and enterprise network.

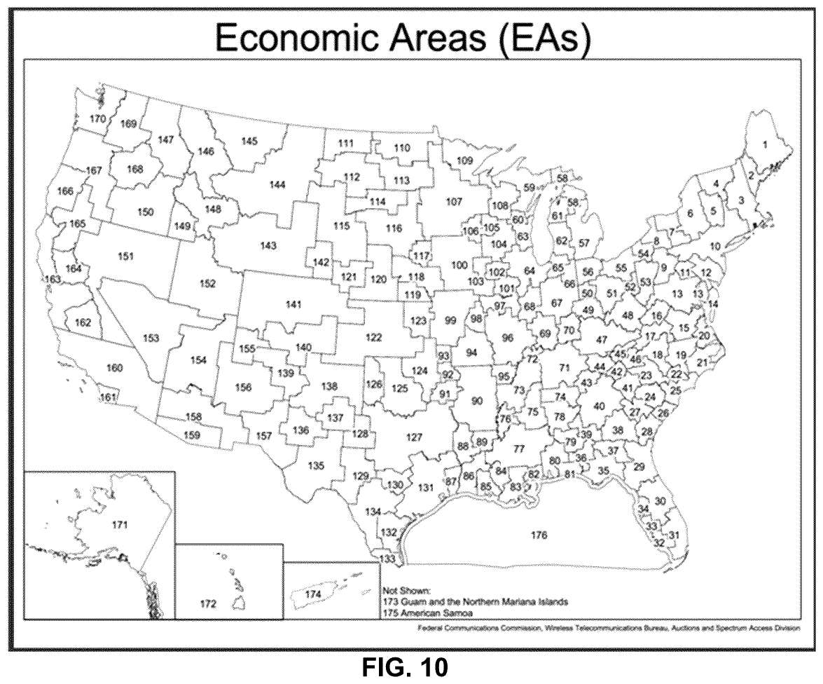

FIG. 10 is a map of FCC Economic Areas.

Identifier Assignments Provided from MNO
TAC-ID
High Byte=0xDE
Low Byte=A single assignment based on FCC economic area
   Cell-ID range=995000-999999

### Private Network Behavior

The neutral host network populates its SIB parameters based on the OnGo Alliance identifiers purchased with the TAC-ID derived from the IBNs and the Cell-ID based the eNB-ID/gNB-IDs procured from OnGo Alliance. The neutral host cell apart from SHNI also populates the MNO PLMN-IDs in its SIB broadcasts.

When the MNO UE attaches to the neutral host, the UE's MNO association is learnt. Based on the MNO association, the TAC-ID and Cell-ID parameters are modified in RRC Connected mode based on the individual MNO authorized TAC-ID and Cell-ID. The UE continues to use this TAC-ID and Cell-ID while operating on a given neutral host cell.

### Connected Mode HO

When the UE transitions from one cell to another in connected mode, the target cell provides the updated set of TAC-ID and Cell-ID parameters.

### Idle Mode HO

Option A: Additionally in Connected mode during the Attach/RRC Configuration, UE obtains a TAI list when it attaches to an LTE network. This list shows the tracking areas where the LTE network believes a UE is located and within which a UE can travel without TAU (Tracking Area Update). The neutral host network also includes the TAC-ID used in the SIB broadcast in the TAC-ID list to avoid the UE sending TAU upon Idle/Inactive transitions from one neutral host cell to another.

Upon transitioning to Idle mode/Inactive mode, the UE continues to use the TAC-ID and Cell-ID provided in connected mode to the UE. When the UE moves from one neutral host cell to another, the UE sees a change of TAC-ID in the new neutral host cell SIB broadcast and if this TAC-ID is present in the TAC-ID list provided to the UE, the UE does not initiate a TAU. The UE continues to use the TAC-ID provided to it in connected mode.

When the UE reenters connected mode, the neutral host network sense the MNO UE and provides the MNO authorized TAC-ID and Cell-ID to the UE.

Option B: As an alternative, the UE is not provided the TAC-ID list including the SIB broadcasted TAC-ID from neutral host cell.

With this option when the UE goes through idle HO, the UE will see a change in TAC-ID and will trigger the UE to send a TAU entering connected mode. The UE is provided the MNO authorized TAC-ID/Cell-ID while in connected mode,

### Aspects to Address

The above information needs to be ratified with all the MNOs and MSOs.

Single TAC-ID within a region will impact UE camping on neighboring private networks. The current procedures provide isolation of private network by using distinct TAC-IDs and private networks providing reject code of #15 to prevent UE reentering a private network where the UE does not have valid credentials.

The Cell-ID range of 5000 is provided. With country wide deployments of neutral hosts, this will not allow for uniquely resolving Cell-IDs within the MNO cores.

In some embodiments, there is a desire to understand if the Cell-ID needs to be unique within an MNO or can be interpreted together with PLMN-ID and/or TAC-ID and how the measurement reports are handled in the MNO core for location determination.

### Identifier Issues Related to Attach Procedure for PCNN UE

In some embodiments, when a UE 212 attempts to camp on an eNB/gNB 208 of a PCNN 202, the UE 212 includes information indicating the “last visited registered TAI” in an attach request message. The last visited registered TAI information indicates the PCNN TAI that was associated with the eNB upon which the UE was last camped. When the MNO network core 214 receives the attempt by the UE 212 to register with the MNO network core 214, the MNO network core 214 (and in particular, an MME within the MNO network core 214) can either interact with the PCNN 202 to retrieve the prior context of the UE 212, or the MNO network core 214 can elect to ignore the previous context and re-establish the full UE context again. In some embodiments, for the MNO network to use the last visited registered TAI, the PCNN TAI is mapped to the MNO TAI. In some embodiments, this mapping is done by the IMD 210 within the PCNN 202. In other embodiments, this mapping is established by the IDM 220 within a Public Neutral Host Identifier Mapping System (NIMS) in the MNO network core 214. The NIMS service is supported on the PCNN 202 by the IDM 210 within the Non-Public NIMS to provide the PCNN-deployed TAIs and Cell-IDs to the MNO NIMS 310. In turn, the IDM 220 within the Public MNO NIMS receives the information from IDM 210 within the Non-Public network NIMS and provides the mapping from the PCNN TAIs to the MNO TAIs and from the PCNN Cell-IDs to the MNO Cell-IDs.

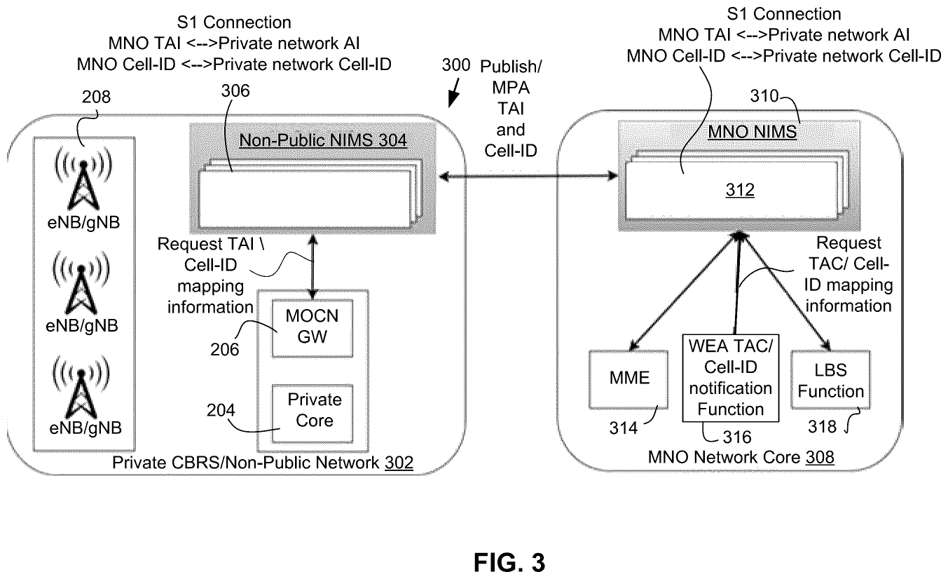

The identifier mapping is performed on a basis of a per 51 connection between the PCNN 202 and the MNO network core 214 (see FIG. 3). The information exchanged between the PCNN NIMS and MNO NIMS is interpreted within the context of an S1 connection.

Given that multiple entities in the PCNN 202 and the MNO network core 214 require the identifier mapping information, in some embodiments, an independent service can be hosted in an appropriate entity having the necessary capability.

### SIB Broadcasts are Based on Private Network TAC-ID and Cell-ID

In some embodiments, the SIB broadcasts are based on private network TAC-ID and Cell-ID. When the MNO UEs associate with the neutral host cell, the UE is provided MNO specific TAC-ID and Cell-ID in RRC connected mode.

### Private Network Behavior

The neutral host network populates its SIB parameters based on the OnGo Alliance identifiers purchased with the TAC-ID derived from the IBNs and the Cell-ID based the eNB-ID/gNB-IDs procured from OnGo Alliance. The neutral host cell apart from SHNI also populates the MNO PLMN-IDs in its SIB broadcasts.

When the MNO UE attaches to the neutral host, the UE's MNO association is learned. Based on the MNO association, the TAC-ID and Cell-ID parameters are modified in RRC Connected mode based on the individual MNO authorized TAC-ID and Cell-ID. The UE continues to use this TAC-ID and Cell-ID while operating on a given neutral host cell.

### Connected Mode HO

When the UE transitions from one cell to another in connected mode, the target cell provides the updated set of TAC-ID and Cell-ID parameters.

### Switching of TAC-ID and Cell-ID in Connected Mode

To prevent the UE from sending Attach or TAU with the TAC-ID and Cell-ID from the SIB broadcasts, the neutral host network ensures that these parameters are switched prior to the NAS signaling messages are exchanged.

In some embodiments, the following occurs:
UE provides the S-TMSI as part of the RRCConnectionRequest.
   a. S-TMSI=S-TMSI (40 bits)=MMEC+M-TMSI; SAE Temporary Mobile Subscriber Identity; Locally identify a UE in short within a MME group (Unique within a MME Pool)
   b. MMEC=MME Code; To identify a MME uniquely within a MME Group.
   c. The 5G-S-TMSI is comprised of the AMF Set ID, AMF Pointer and 5G-TMSI
The neutral host network is provisioned with the MNO/MVNO association with the MMEC identifier.
The neutral host network sends the RRCConnectionReconfiguration providing the modified SIB1 parameters including the TAC-ID and Cell-ID associated with the MNO/MNVO
These are performed with SRB1 without allowing NAS messages to be forwarded to the packet core network until RRCConnectionReconfigurationComplete is received.
The NAS messages received from the UE after the RRCConnectionReconfigurationComplete are forwarded to the packet core.
eNB records the S-TMSI for which the TAC-ID and Cell-ID has been changed to the MNO identifiers. Subsequent connections, the reconfiguration procedures are not performed. When the UE moves out a given cell, this information is deleted so that when the UE reenters, this procedure can be run.

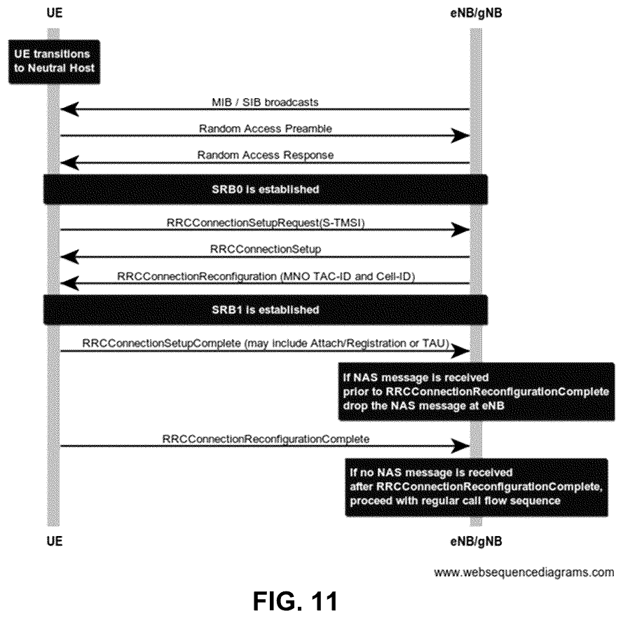

FIG. 11 is an illustration of the TAC-ID and CELL-ID are modified in connected mode.

### Idle Mode HO

In some embodiments, additionally in Connected mode during the Attach/RRC Configuration, UE obtains a TAI list when it attaches to an LTE network. This list shows the tracking areas where the LTE network believes a UE is located and within which a UE can travel without TAU. The neutral host network also includes the TAC-ID used in the SIB broadcast in the TAC-ID list to avoid the UE sending TAU upon Idle/Inactive transitions from one neutral host cell to another.

Upon transitioning to Idle mode/Inactive mode, the UE continues to use the TAC-ID and Cell-ID provided in connected mode to the UE. When the UE moves from one neutral host cell to another, the UE sees a change of TAC-ID in the new neutral host cell SIB broadcast and if this TAC-ID is present in the TAC-ID list provided to the UE, the UE does not initiate a TAU. The UE continues to use the TAC-ID provided to it in connected mode.

When the UE reenters connected mode, the neutral host network sense the MNO UE and provides the MNO authorized TAC-ID and Cell-ID to the UE.

In other embodiments, as an alternative, the UE is not provided the TAC-ID list including the SIB broadcasted TAC-ID from neutral host cell.

With this option when the UE goes through idle HO, the UE will see a change in TAC-ID and will trigger the UE to send a TAU entering connected mode. The UE is provided the MNO authorized TAC-ID/Cell-ID while in connected mode.

In some embodiments, MMEC identifier will point to the roaming partner MNO (e.g., MNO-2) rather than the home network (e.g., MNO-1) when the UE transitions to the neutral host from a roaming partner MNO (MNO-2). Although this may not be typical with the USA MNO devices, it may have implications with preferred camping for international roaming agreements.

In some embodiments, a situation can arise in which a NHN (Neutral Host Network) supports only a first MNO (MNO-1), but a second MNO (MNO-2) macro network does not transition the UE to the MNO-2 MHN. In such situations, there is an expectation that the UE is offloaded to NHN supporting MNO-1. In some embodiments the UE performs HPPLMN scans to find the NHN and transitions to the NHN in idle mode. The UE may be provisioned with the geofence of the available NHNs and the UE may use that information to pro-actively transition to the NHN supporting MNO-1.

In some embodiments, a situation may arise in which a NHN supports both MNO-1 and MNO-2. The expectation is that the UE will camp on the NHN, but with MNO-1 configuration and avoid roaming with MNO-2. In such situations, some embodiments are such that the UE performs HPPLMN scans to find the NHN and transitions to the NHN in idle mode. The UE may be provisioned with the geofence fence information of the available NHNs and the UE uses that to pro-actively transition to the NHN supporting MNO-1.

### MNO Obtains a Semi-Independent PLMN-ID for Enterprise Neutral Host Operation

In some embodiment, each MNO obtains a semi-independent PLMN-ID for enterprise neutral host operation.

The enterprise network supporting neutral host is deployed with the TAC and Cell-ID associated with the SHNI. This information is provided to the MNOs. The expectation is that these TACs and Cell-IDs are unique within each of the MNOs PLMNs used by the UE to camp on the neutral host network.

This MNO identified PLMN for neutral host is populated in the SIM credential PLMN list for the UE to camp on the enterprise network. The relative prioritization of this MNO identified PLMN for neutral host camping can be specified in the PLMN list. Additionally, radio procedures for transitioning from the macro network to the enterprise network can be coordinated based on SIB broadcasts from the macro network.

Current TAC and Cell-ID Assignment Procedures from CBRS

There are 6 TAC per IBN purchased assigned. There are 10K IBNs, resulting in 60K TACs that can be associated with the IBN purchases. TAC is a 16-bit identifier. 2\hat{ }16−60K=5536 can be “locally” allocated and independently purchased from OnGoA.

The Cell-ID are individual purchased and associated with the SHNI to form the ECGI.

### Aspects to Address

Initial input is not received is some embodiments. In such embodiments, this is ratified with all the MNOs and MSOs.

In some embodiments, a semi-independent PLMN can be accommodated for NHN in the MNO cores together with a larger space of TAC-ID/Cell-ID supported.

### Handling of TAI List in PCNN

In response to receipt of the last visited registered TAI within the MNO network core 214, the MNO network core 214 (and in some embodiments, the MME within the MNO network core 214) provides a TAI list (i.e., a list of tracking areas identified by TAIs) to which the UE 212 can transition without the need to send a TAU message. The TAIs within the list are mapped to PCNN TAIs either by the IMD 210 within the MNO network core 214 or the IMD 210 within the PCNN 202.

In some embodiments, the MNO network core 214 does not provide a TAI list in response to receiving the last visited registered TAI. That is, since PCNNs are typically small enough that all of the eNBs/gNBs within the PCNN may be held within the same TAI, or within a group of TAIs that are sufficiently related to one another that no TAU is necessary, it can be assumed that there is no need for a TAI list. The size of the PCNN also limits the paging area for the UE. It should be noted that when one or more active sessions are to be transitioned from the PCNN 202 to the MNO core network 216, the prior UE context is retrieved to establish real-time services, such as voice over LTE (VoLTE).

E-911 Calls from PCNN UE

Unlike the case in which a UE 104 is communicating through an MNO eNB/gNB 114, when a UE 212 is communicating through an eNB 208 that is part of a PCNN 202 (i.e., a PCNN UE), the MNO network does not have access to the PCNN Cell-ID and the PCNN TAI of the PCNN eNB 208. Rather, the MNO assigns an MNO Cell-ID and an MNO TAI to the MOCN gateway 206. The MOCN gateway 206 is then responsible for determining which of the PCNN eNB s/gNB s 208 to send the communication stream to, based on the International Mobile Subscriber Identity (IMSI) of the PCNN UE 212 to which the communication is being directed. Furthermore, when a PCNN UE 212 makes an E-911 call, the position location information provided by the PCNN UE 212 in response to the request from the E-SMLC in the MNO core 214 will include PCNN Cell-IDs and PCNN TAIs for which the MNO network has no knowledge (and in particular, no position location information from which to determine the location of the PCNN UE 212). The IMD 210 provides a means by which the MNO network 202 can map the PCNN Cell-ID and PCNN TAI to an MNO Cell-ID and MNO TAI for which the MNO will have position location information. This information can then be provided to a PSAP 226.

In some embodiments of the disclosed method and apparatus, the IMD 220 is located within the E-SMLC 222. Locating the IMD 220 in the E-SMLC 222 allows the operation of the disclosed method and apparatus with the least impact on a standard LTE architecture, as defined by 3GPP standards. In some embodiments, an IMD 210 may also be located within the PCNN 202. Accordingly, any Cell-IDs and TAIs can be mapped within the PCNN 202. In some embodiments, the IMD 220 in the MNO network core 214 is capable of mapping local PCNN Cell-IDs and TAIs, for several different PCNNs 202, to the MNO Cell-IDs and TAIs. In some embodiments, mappings are maintained based on S1 connectivity established with the MOCN gateways 206 for each PCNN 202. In some embodiments, the same MOCN gateway 206 is capable of communicating with more than one PCNN 202 (note that only one is shown for the sake of simplicity).

Request for Commercial Location Based Services from PCNN UE

Similar to the case in which a PCNN UE 212 makes an E-911 call, when a PCNN UE 212 attempts to access position location services, the PCNN UE 212 provides position location information that the MNO uses to determine the position of the PCNN UE 212. Accordingly, for servicing requests for commercial LBS from the PCNN UE 212, the same type of IMD database look-up and mapping (as the identifier mapping described above) maps the PCNN Cell-IDs and TAIs (if appropriate for the particular type of position location services) to MNO Cell-IDs and TAIs. Based on this mapping, the MNO E-SMLC 222 can determine the location of the PCNN UE 212 and provide that location to a commercial LCS client 228.

It can be seen from the above description that the Location Based Service (LBS) procedures are initiated from the MNO core 214, via LBS function 224. However, such LBS procedures depend on PCNN identifiers for Radio Access Technology (RAT) dependent measurements in order for the PCNN UE 212 to report position location information. The MNO core 214 issues these requests to the UE 212, based on the PCNN identifiers, by mapping from the MNO identifiers to the PCNN identifiers. Accordingly, for LPPa and New Radio Position Protocol A (NRPPa) procedures, the PCNN 202 performs the required translations to the MNO network identifiers to report the information to the MNO core 214.

### Emergency Messages Sent Through the Public Warning System (PWS) to PCNN UEs

In some embodiments in which a PWS message is sent to PCNN UEs 212, the IMD 210 is located either within the MOCN gateway 206 or relatively tightly coupled to the MOCN gateway 206. In either case, by having the IMD 210 located within the PCNN 202, the impact on standard MNO networks to which the PCNN UEs interact is minimized. In some embodiments, an IMD 220 is also located within the MNO core 214.

When the LCS client 228 is the Wireless Emergency Alert (WEA) Notification Provider 230 attempting to send a PWS notification message, the notification is sent to an MNO Cell-ID and MNO TAI together with the notification area information. The MOCN gateway 206 then uses an IMD 210 to map to those of the PCNN Cell-IDs and the PCNN TAIs that are within the notification area.

### Alternatives

In some embodiments in which it is difficult or undesirable to map PCNN Cell-IDs and PCNN TAIs to MNO Cell-IDs and MNO TAIs (and in other cases), the following alternative schemes may be implemented in accordance with the disclosed method and apparatus.

### PCNN Direct Connectivity to WEA Notification Providers

In some embodiments, the PCNN network 302 obtains emergency alerts and supports the broadcasts independently. To support the broadcasts independently, the APs 208 to which the broadcast needs to be sent are determined based on the notification area(s) indicated in the message. MNO-initiated WEAs do not need to be processed because the PCNN 302 handles the WEAs independently.

WEAs Forwarded to the PCNN from the MNO

The expectation is that the WEAs received from the Notification Provider 230 are forwarded to the PCNN 202 from the MNO include information regarding the notification area where the message needs to be delivered. One or more regions where PCNN sites/APs are located and where the information needs to be broadcasted are determined by having the PCNN 202 match the cell sites to the required notification areas.

The PCNN 202 uses the WEAs provided by only one of the MNOs. The choice of the MNO is based on the specific regions based on the WEAs routed to the PCNN 202 and on where neutral hosts are deployed that are associated with specific MNOs. The target UE is identified based on the MNO chosen, as described in the next section.

### PCNN Matching Cell Sites to Required Notification Areas

The WEAs received from the Notification Provider 230 are forwarded to the PCNN 202 from the MNO. The WEAs include the notification area where the message needs to be delivered. The PCNN sites/APs, etc., to which the information needs to be broadcasted, are determined by the PCNN 202 matching the cell sites to the required notification area.

The received WEAs are delivered as a broadcast after removing duplicates across MNOs by comparing the contents and combining the required area of delivery based on the notifications received from the individual MNO cores.

In some embodiments, each MNO obtains a PLMN-ID for enterprise-neutral host operations. The enterprise network supporting the neutral host is deployed with a Timing Advance Command (TAC) and Cell-ID associated with a Shared Host Neutral Identity (SHNI) (the EUTRAN Cell Global Identifier (ECGI) is a combination of the SHNI and the Cell-ID, and the TAI is a combination of the TAC and the SHNI). The UE adjusts its transmission timing when a TAC is received.

The TAC and Cell-ID are provided to the MNOs. The TACs and Cell-IDs associated with a PLMN are unique within that PLMN. The TAC indicates the change of the uplink timing relative to the current uplink timing and the time it takes the radio wave to reach the UE. The distance to the UE and therefore the location of the UE can be determined from the TAC. The Cell-IDs are used for routing messages via the neutral host network to the UEs.

A network device associated with the neutral host or the PLMN stores a list of Subscriber Identity Module (SIM) credentials associated with a neutral host so that the UE can receive and send messages on the enterprise network. The relative prioritization of this PLMN (identified by the MNO) for the usage of the neutral host can be specified in the PLMN list. Additionally, radio procedures for transitioning from the macro network to the enterprise network can be coordinated based on System Information Broadcasts (SIB) from the macro network.

### S6a/S8 Based Neutral Host Architecture

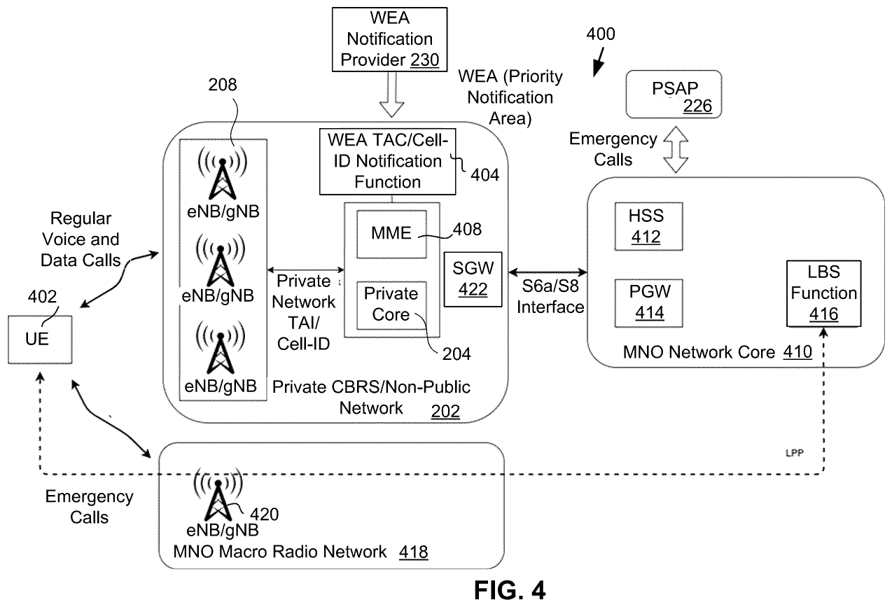

FIG. 4 illustrates an S6a/S8-based neutral host architecture 400. In neutral host A\architecture 400, UE 402 places regular voice calls using PCNN 202. PCNN 202 includes APs 208, which connects, via private-network TAI and cell ID, with a private network having the private core 204, the MME 408 and SGW 422. PCNN 402 is connected, via an S6a/S8 interface, to MNO Network Core 410. MNO Network Core 410 includes HSS 412, PGW 414, and LBS Function 416. Neutral host Architecture 400 also includes MNO macro network 418, which has AP 420. Neutral host Architecture 400 also includes PSAP 418 and WEA notification provider 422. PSAP 418 interacts with MNO network core 410, facilitating emergency communications. WEA notification provider 230 sends WEA notification to PCNN 202. Emergency calls are sent, via MNO macro radio network 418, AP 420, MNO Network Core 410 and LBS function 416.

In the embodiments associated with FIG. 4, a roaming connection is established, via the S6a/S8 interface, between PCNN 202 (i.e., the enterprise network) and the MNO network core 410. In some embodiments, the S6a/S8 interface may be replaced with any interface for roaming interface. The S6a interface (between PCNN 202/MME 408 and MNO Network Core 410/HSS 412) enables the transfer of subscription and authentication data. The S8 interface (between the SGW 422—within private core 204—and the PGW 414) provides an Inter-PLMN reference point with a user plane and control plane between the SGW and the PGW 414.

Referring to FIG. 4, in some embodiments, the MME 408 and SGW 422 are housed in the enterprise network (PCNN 202), providing support for CMAS/ETWS, which are managed independently by the PCNN 202 without the support of MNO Network Core 410. Also, emergency calling is disabled in the enterprise network/PCNN 202, and instead of using the emergency calling of the PCNN 202, the UE 402 finds an available MNO macro network 418 to place the emergency call.

S6a/S8 Based Neutral Host Architecture without an MNO Macro Network

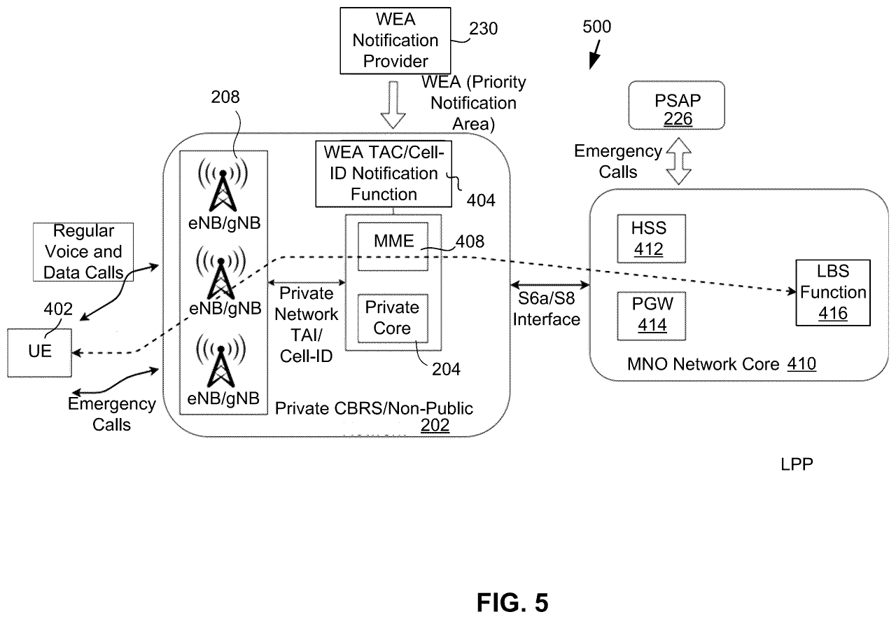

FIG. 5 illustrates an S6a/S8-based neutral host Architecture 500 that does not use an MNO macro network. In the embodiment of FIG. 5, emergency calls are also supported on the enterprise network (in contrast to the embodiments of FIG. 4), and the UE 402 sends emergency calls to PCNN 202. The LPP protocol uses the control plane and routes the messages through the MME 408 of the PCNN 202. The MME 408 maps the MNO-network-assigned-Cell-ID to the enterprise-assigned-Cell-ID when forwarding the message to the UE 402. When the UE 404 reports the measurement information, the MME 408 receives the measurement information. At the MME 408, the PCNN Cell-ID is converted to the MNO Cell-ID before forwarding the information to the MNO network core 410. Using the neutral host Architecture 400 and 500, the MNO Network Core 410 and the MNO Network do not need to be altered.

S6a/S8 Based Neutral Host Architecture with Private Host and IMSI Server

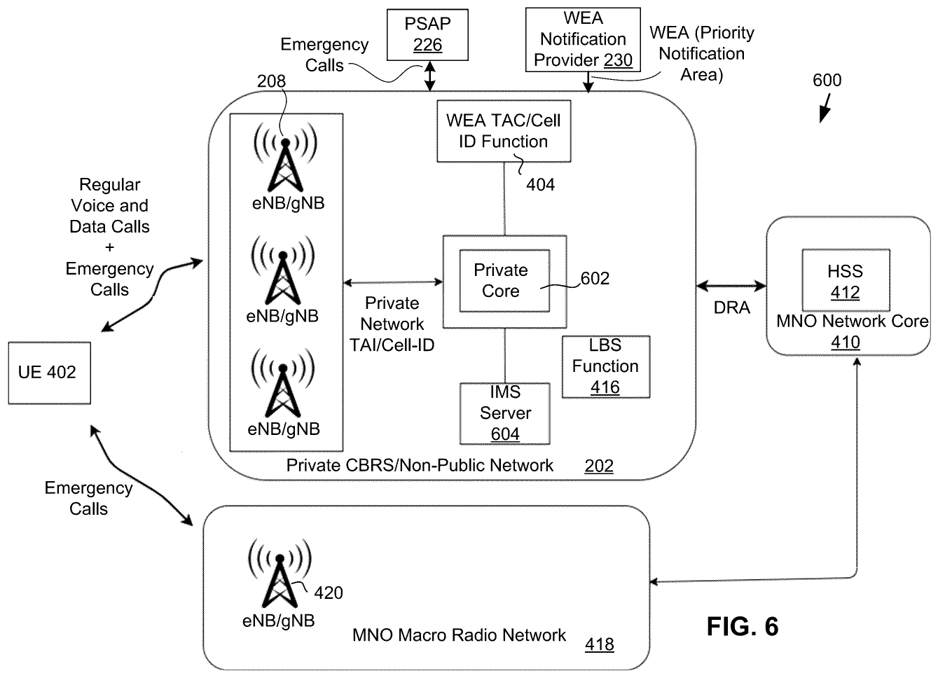

FIG. 6 illustrates an S6a/S8-based neutral host Architecture 600. Neutral host Architecture 600 is similar to neutral host architecture 400 of FIG. 4. However, neutral host architecture 600 has private host 602 and IMS server 604. Also, LBS function 416 is located in PCNN 202. The PCNN 202 has a Diameter Routing Agency (DRA) connection with MNO network core 410. The DRA may also be referred to as a Diameter Signaling Controller (DSC).

The UE 402 places regular voice calls using the PCNN 202. PCNN 202 includes APs 208, which connects, via private-network TAI and cell ID, with a private network having the private core 204 and the MME 408. PCNN 402 is connected, via an S6a/S8 interface, to MNO Network Core 410. MNO Network Core 410 includes HSS 412, PGW 414, and LBS Function 416. Neutral host architecture 600 also includes MNO macro network 418, which has AP 420. Neutral host architecture 600 also includes PSAP 418 and WEA notification provider 422. PSAP 418 interacts with MNO network core 410, facilitating emergency communications. WEA notification provider 230 sends WEA notification to PCNN 202. Emergency calls are sent, via MNO macro radio network 418, AP 420, MNO Network Core 410 and LBS function 416.

In the embodiment of FIG. 6, PCNN 202 (or another enterprise network) is treated as a roaming partner. In the embodiment of FIG. 6, the UEs camped on PCNN 202 need to support IMS voice/video calling to receive the WEA. The IMS-based service is deployed, via IMS server 604, on the enterprise campus along with the authentication required for the UE 402 to connect to the Proxy Call Session Control Function (P-CSCF).

The UE 402 is authenticated with the HSS 412, via a DRA. In some embodiments, the DRA of FIG. 6 enables a Policy and Charging Rules Function (PCRF) discovery and selection as part of a Policy Charging and Control (PCC) architecture. IN some embodiments, if multiple PCRFs are available, the DRA ensures an appropriate PCRF is initially selected and subsequently ensures that this PCRF is used for future transactions associated with the subscriber. In some embodiments, the DRA routes of Diameter messages.

Connectivity to the WEA notification provider 230 is supported, for sending a WEA, within PCNN 202, via WEA TAC/cell-ID notification function 404.

The UE 402 leaves the PCNN 202 (or another enterprise network) to find a macro network for enabling emergency calling. The embodiment of FIG. 6 enables emergency calling together with LBS service (via LBS function 416) on the campus of PCNN 202.

In some embodiments, each MNO obtains a PLMN-ID for enterprise-neutral host operations. In some embodiments, the enterprise network supporting the neutral host is deployed with the TAC and Cell-ID associated with the SHNI, and this information is provided to the MNOs. The expectation is that these TACs and Cell-IDs are unique within each MNO PLMN used by the UE to camp on the neutral host network.

This MNO-identified PLMN for a neutral host is populated in the SIM credential PLMN list for the UE to camp on the enterprise network. The relative prioritization of this MNO-identified PLMN for neutral host camping can be specified in the PLMN list. Additionally, radio procedures for transitioning from the macro network 418 to the PCNN 202 can be coordinated based on SIB broadcasts from the macro network 418.

In some embodiments, eNB-IDs/gNB-IDs are individually purchased and associated with the SHNI to form the E-UTRAN Cell Global Identifier (ECGI). The ECGI is a global identifier. In some embodiments, the ECGI includes an MCC (Mobile Country Code), MNC (Mobile Network Code) and the ECI (E-UTRAN Cell Identifier).

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
determining, based on a location component, one or more particular UEs (User Equipment) that are communicating via a private network; and
directing an emergency message to a subset of Access Points (APs) within the private network based on the one or more particular UEs determined.

2. The method of claim 1, wherein private network operates a Citizens Broadband Radio System (CBRS) network architecture and the location component comprises an Evolved Serving Mobile Location Center (E-SMLC) of an MNO.

3. The method of claim 1, wherein the location component is located in the private network.

4. The method of claim 1, wherein determining comprises providing location information in response to requests made in accordance with Location Positioning Protocol (LPP).

5. The method of claim 4, wherein providing the location information includes LPP messaging, the LPP messaging being communicated on a secure tunnel that allows contents of communications to only be accessible to the UE and the network location component.

6. The method of claim 1, wherein determining includes requesting an identifier of one or more particular UEs, and wherein the method further comprises sending a response to the request, the response including information related to APs with local Tracking Area Identifiers (TAIs) and local AP identifiers.

7. The method of claim 6, wherein the information related to the APs includes AP identifiers, the AP identifiers not being unique for all Public Land Mobile Networks (PLMNs).

8. The method of claim 1, wherein determining includes providing a mapping between a private network AP identifier and a local Mobile Network Operators (MNO) AP-identifier that is unique within an MNO network.

9. The method of claim 8, the mapping being provided by a public Neutral Host Identifier Mapping System (NIMS) to local MNOs.

10. The method of claim 9, wherein the particular LCS client is a Public Safety Answering Point (PSAP).

11. The method of claim 10, further comprising the PSAP sending a request for the UE to provide information regarding a location of the UE in coordination with an Evolved Serving Mobile Location Center (E-SMLC) within the MNO network.

12. The method of claim 1, further comprising:
a) receiving at an enterprise network, an emergency call from the UE, and
b) routing, by the enterprise network, the emergency call, based on a Location Service (LCS) client.

13. The method of claim 1, the determining comprising:
a) sending a request for information about an identity of one or more components of a Mobile Network Operators (MNO) network; and
b) sending a response to the request, the response having the information about the identity of the one or more components of the MNO network.

14. The method of claim 1, further comprising:
a) storing an IMD in association with a MOCN gateway; and
b) mapping, by the MOCN gateway, a PCNN Cell-ID and a PCNN TAI with a notification area.

15. The method of claim 1, further comprising:
a) receiving an emergency message at the private network, the emergency message including a notification area;
b) matching, by the private network, cell sites with the notification area; and
c) broadcasting, by the private network, to the cell sites.

16. The method of claim 15, further comprising:
a) receiving a first emergency message from a first Mobile Network Operators (MNO) and a second emergency message from a second MNO, the second emergency message being a duplicate of the first emergency message;
b) determining that the second emergency message is the duplicate of the first emergency message; and
c) removing the second emergency message.

17. The method of claim 1, further comprising:
a) establishing a roaming connection between the enterprise network and a Mobile Network Operators (MNO) network core; and
b) transferring authentication data between the enterprise network and the MNO network core.

18. The method of claim 1, further comprising:
a) receiving at an enterprise MME measurement information from the UE; and
b) mapping an enterprise Cell-ID to a Mobile Network Operators (MNO) Cell-ID before forwarding measurement information to an MNO network.

19. The method of claim 1, the UE placing an emergency call, via a Mobile Network Operators (MNO) macro network and Location Based Service (LB S) function of an MNO network core, to a Public Safety Answering Point (PSAP).

20. A network system comprising one or more network devices having:
a) one or more processor systems; and
b) one or more memory systems storing one more machine instructions, which when implemented, cause the one or more network devices to implement a method including at least:
i. determining, based on a location component, one or more particular UEs (User Equipment) that are communicating via a private network; and
ii. directing an emergency message to a subset of Access Points (APs) within the private network based on the one or more particular UEs determined.
